(19) United States
(12) Patent Application Publication
(10) Pub. No.: US 2026/0311055 A1
(43) Pub. Date: Oct. 8, 2026

(54) MANAGING LATENT REPLAYS AT UE SIDE DURING STATEFUL MODEL UPDATE AT A GNB AND/OR UE

(71) Applicant: Nokia Technologies Oy, Espoo (FI)

(72) Inventors: István Zsolt KOVÁCS, Aalborg (DK); Vismika Maduka RANASINGHE MUDIYANSELAGE, Oulu (FI); Muhammad Majid BUTT, Naperville, IL (US); Fahad SYED MUHAMMAD, Massy (FR); Afef FEKI, Massy (FR); Sakira HASSAN, Espoo (FI)

(21) Appl. No.: 19/485,778

(22) PCT Filed: Mar. 28, 2024
(86) PCT No.: PCT/EP2024/058412

§ 371 Date: Nov. 19, 2025

(30) Foreign Application Priority Data
Jun. 8, 2023 (GB) 2308551.7

(51) Int. Cl. G06N 20/00

(52) U.S. Cl. CPC G06N 20/00

(57) ABSTRACT

Example embodiments may relate to systems, methods and/or computer programs for managing latent replays for use in continual learning in a networked system. According to a first aspect of this specification, there is described apparatus, comprising means for: executing a first model part of a machine-learning model to generate an intermediate model output, wherein the machine-learning model is a two-sided machine-learning model comprising the first model part for execution by the apparatus and a second model part for execution at a further apparatus; causing transmission of the intermediate model output to the further apparatus; updating the first model part of a machine-learning model; generating, in response to one or more trigger conditions from a set of trigger conditions, one or more latent replay samples, the one or more latent replay samples each comprising an intermediate model output generated by the updated first model part of the machine-learning model from a respective refence input; and transmitting, to the further apparatus, one or more of the latent replay samples.

### FIELD

Example embodiments may relate to systems, methods and/or computer programs for managing latent replays for use in continual learning in a networked system.

### BACKGROUND

Artificial Intelligence (AI) and machine-learning (ML) solutions are gaining increasing interest from device vendors thanks to big advances on the integration of these advanced methods into chipsets. Recent chipset development has resulted in chipsets that are highly optimized for ML functionalities and deep neural network processing, with extreme low power consumption and high compute.

Continual Learning (CL) is defined as a fundamental idea in machine learning in which ML models continuously learn and evolve based on the input of increasing amounts of data while retaining previously learned knowledge. CL generally falls under two main categories: stateful training; and online training. Stateful (re)training occurs when an ML model continues training on new data, e.g., fine-tuning the ML model. In particular, the model is iterated and updated using the same model architecture and features but with new data/a new dataset. In general, the size of the data (dataset) is much less during re-training than the data used for initial training. Stateful (re)training can use automated training procedures. Stateless (re)training occurs when an ML model is trained from scratch each time. Changing the ML model architecture, or adding a new feature, requires training the new ML model from scratch i.e., a model iteration. Stateless (re)training can use manual or automated training procedures.

One issue for computational models using lifelong learning is that they can be prone to catastrophic forgetting or catastrophic interference, i.e., training a model with new information interferes with previously learned knowledge. This phenomenon typically leads to an abrupt performance decrease or, in the worst case, to the old knowledge being completely overwritten by the new one.

### SUMMARY

The scope of protection sought for various embodiments of the invention is set out by the independent claims. The embodiments and features, if any, described in this specification that do not fall under the scope of the independent claims are to be interpreted as examples useful for understanding various embodiments of the invention.

According to a first aspect of this specification, there is described apparatus, comprising means for: executing a first model part of a machine-learning model to generate an intermediate model output, wherein the machine-learning model is a two-sided machine-learning model comprising the first model part for execution by the apparatus and a second model part for execution at a further apparatus; causing transmission of the intermediate model output to the further apparatus; updating the first model part of a machine-learning model; generating, in response to one or more trigger conditions from a set of trigger conditions, one or more latent replay samples, the one or more latent replay samples each comprising an intermediate model output generated by the updated first model part of the machine-learning model from a respective refence input; and transmitting, to the further apparatus, one or more of the latent replay samples.

The set of trigger conditions may comprise the updating of the first model part of a machine-learning model.

The apparatus may further comprise means for: receiving, from the further apparatus, a request for latent replay sample updates. The set of trigger conditions may comprise receiving, from the further apparatus, the request for latent replay sample updates.

The apparatus may further comprise means for: receiving, from the further apparatus, further apparatus capability information comprising one or more evaluation criteria for selecting latent replay samples for transmission to the further apparatus; evaluating, using the one or more latent replay samples generated after an update of the first model part of the machine learning model, the one or more evaluation criteria; and selecting, based on the evaluation of the one or more evaluation criteria, one or more of the latent replay samples for transmission to the further apparatus.

The apparatus may further comprise means for: storing one or more previous latent replay samples generated by the first model part of a machine-learning model. The means evaluating the one or more evaluation criteria may comprise means for comparing the one or more latent replay samples generated after an update of the first model part of the machine learning model to a corresponding one or more previous latent replay samples generated prior to said update of the first model part of the machine learning model. Comparing the one or more latent replay samples to the corresponding one or more previous latent replay samples may comprise determining a difference in latent space between each of the one or more latent replay samples and the corresponding previous latent replay samples; and selecting the one or more of the latent replay samples for transmission to the further apparatus is based on the difference in latent space between each of the one or more latent replay samples and the corresponding previous latent replay samples being above a threshold value.

The apparatus may be a base station. The further apparatus may be a user equipment. Alternatively, the apparatus may be a user equipment and the further apparatus may be a user equipment.

The set of trigger conditions comprises a handover of the user equipment to the base station from a further base station. The apparatus may further comprise means for: receiving, from the user equipment, data indicating a model identity and/or model capability of the second model part of the machine-learning model; determining whether a set of latent replays stored at the user equipment is compatible with the first model part of a machine-learning model based on the model identity and/or model capability of the second model part of the machine-learning model. The set of trigger conditions may further comprise a determination that the first model part of a machine-learning model is not compatible with the set of latent replays stored at the user equipment.

The apparatus may further comprise means for: requesting, from the further base station, a set of latent reference samples; receiving, from the further base station, the set of latent reference samples; and comparing the received set of latent reference samples to the one or more latent replay samples generated at the apparatus. Transmitting, to the user equipment, one or more of the latent replay samples may be based on the comparison of the received set of latent reference samples to the one or more latent replay samples generated at the apparatus.

The first model part of the machine learning model may comprise an adaptive stage that is updated using continuous learning techniques and frozen stage that is updated less frequently than the adaptive stage.

According to a further aspect of this specification, there is described apparatus, comprising means for: receiving, from a further apparatus, an intermediate output of a machine-learning model, wherein the machine-learning model is a two-sided machine-learning model comprising a first model part executed at the further apparatus and a second model part for execution by the apparatus; generating, from the intermediate output, a model output using the second model part of the machine-learning model; storing a set of latent replay samples; updating, based at least in part on the set of latent replay samples, the second model part of the machine-learning model; receiving, from the further apparatus or a further base station, one or more updated latent replay samples, the one or more updated latent replay samples comprising an updated intermediate model output generated by an updated first model part of the machine-learning model; and updating the set of latent replay samples based on the one or more updated latent replay samples.

The apparatus may further comprise means for: evaluating a request criterion for requesting updated latent replay samples; and requesting, from the further apparatus, the one or more updated latent replay samples in response to a positive evaluation of the request criterion.

The apparatus may further comprise means for: comparing the one or more updated latent replay samples to a corresponding one or more latent replay samples stored at the apparatus. The means for updating the set of latent replay samples based on the one or more updated latent replay samples may comprise means for selecting, based on the comparison of the one or more updated latent replay samples to the corresponding one or more latent replay samples stored at the apparatus, one or more of the updated latent replay samples for storage at the apparatus.

The apparatus may further comprise means for: transmitting, to the further apparatus, a configuration message comprising one or more evaluation criteria for use by the further apparatus to select latent replay samples for transmission to the apparatus.

The apparatus may be a user equipment and the further apparatus may be a base station. Alternatively, the apparatus may be a base station and the further apparatus may be a user equipment.

The apparatus may further comprise means for: performing one or more measurements of signal quality of signals from the base station and a further base station; determining to switch connection from the base station to the further base station; and transmitting, to a further base station, data indicating a model identity and/or model capability of the second model part of the machine-learning model in response to determining to switch connection to the further base station.

The apparatus may further comprise means for: transmitting, to the base station or the further base station, a configuration complete message comprising an indication that updated latent replay samples are stored at the apparatus.

The second model part of the machine learning model may comprise an adaptive stage that is updated using continuous learning techniques and frozen stage that is updated less frequently than the adaptive stage.

According to a further aspect of this specification, there is described a computer implemented method comprising: executing a first portion of a machine-learning model to generate an intermediate model output, wherein the machine-learning model is a two-sided machine-learning model comprising the first model part for execution at a first apparatus and a second model part for execution at a second apparatus; causing transmission of the intermediate model output to the second apparatus; updating the first model part of a machine-learning model; generating, in response to one or more trigger conditions from a set of trigger conditions, one or more latent replay samples, the one or more latent replay samples each comprising an intermediate model output generated by the updated first model part of the machine-learning model from a respective refence input; and causing transmission of one or more of the latent replay samples to the second apparatus.

According to a further aspect of this specification, there is described a computer implemented method comprising: receiving, from a first apparatus, an intermediate output of a machine-learning model, wherein the machine-learning model is a two-sided machine-learning model comprising a first model part executed at the first apparatus and a second model part for execution by a second apparatus; generating, from the intermediate output, a model output using the second model part of the machine-learning model; updating, based at least in part on a set of latent replay samples, the second model part of the machine-learning model; receiving, from the first apparatus or a further apparatus, one or more updated latent replay samples, the one or more updated latent replay samples comprising an updated intermediate model output generated by an updated first model part of the machine-learning model; and updating the set of latent replay samples based on the one or more updated latent replay samples.

Further aspects of this specification describe systems, apparatus and computer program products for carrying out any one or more of the methods described herein.

### BRIEF DESCRIPTION OF THE DRAWINGS

Example embodiments will now be described by way of non-limiting example, with reference to the accompanying drawings, in which:

FIG. 1 shows an overview of a network system for implementing a two-sided ML model;

FIG. 2A shows an example of a two-sided ML model;

FIG. 2B shows a further example of a two-sided ML model;

FIG. 3 shows an example signalling diagram for updating latent replays of a two-sided ML model;

FIG. 4 shows a further example signalling diagram for updating latent replays of a two-sided ML model;

FIG. 5 shows an overview of a handover scenario for a UE between two base stations;

FIG. 6 shows an example signalling diagram for the initial stages of a handover of a UE between two base stations;

FIG. 7 shows an example signalling diagram for updating reference latent replay samples stored at a UE after a handover procedure between a source base station and a target base station;

FIG. 8 shows a further example signalling diagram for updating reference latent samples stored at a UE after initiation/completion of a handover procedure between a source base station and a target base station;

FIG. 9 shows a further example signalling diagram for updating reference latent samples stored at a UE after initiation/completion of a handover procedure between a source base station and a target base station;

FIG. 10 shows a flow diagram of an example method for managing a set of latent replay samples in a two-sided ML model;

FIG. 11 shows a flow diagram of a further example method for managing a set of latent replay samples for a two-sided ML model;

FIG. 12 shows an apparatus according to some example embodiments; and

FIG. 13 shows a non-transitory media according to some embodiments.

### DETAILED DESCRIPTION

This specification describes systems, methods and apparatus for managing latent replays during continuous learning in a two-sided ML model in a resource efficient manner, where one side of the model is executed at a network/gNB, and the other side of the model is executed at a user equipment (UE).

One approach to address the issue of catastrophic forgetting in CL is to freeze part of the ML model (the “frozen stage” or “frozen layers”) and only adapt the unfrozen parts (the “adaptive stage” or “adaptive layers”) during retraining. This approach is good for HW limited devices such as mobile user terminals. New knowledge is applied only to the adapted stage while the frozen stage will continue holding the old knowledge.

Latent replays (LRs) can be used to alleviate catastrophic forgetting by means of continuous (stateful) learning of the adaptive stage. The idea behind LRs is to combine a few old data points taken from the original training set but encoded into a low-dimensional latent space to reduce the memory cost, with the new data for the incremental learning tasks. Hence, the previous knowledge is retained by means of latent replays samples, e.g., the intermediate feature maps of the ML model inference (also referred to herein as “latent samples”). These intermediate feature maps typically require less space to store than the input data (e.g., up to 48×smaller compared to raw images). This strategy also leads to reduced computational cost: the latent intermediate layer splits the ML model into a frozen stage at the front and an adaptive stage later in the model. The adaptive stage is updated during continuous learning using the new input data and the latent replay data.

LR samples have to represent the correct input conditions to allow high learning accuracy. However, for further performance improvements of an ML model, the frozen stage can also be updated, e.g., updated infrequently or occasionally. This poses a problem as the frozen stage updates can result in LR samples with different statistical properties to the LR samples before re-training, hindering the training of the adaptive stage. Consequently, it is desirable to update LR samples when the frozen stages of an ML model are updated.

A two-sided ML model is an ML model in which the ML functionality is provided by a first part of the ML model executed in a first component of the network (e.g., a base station or a UE), and a second part of the ML model executed in a second component of the system that is different from the first component (e.g., a UE or a base station respectively). In such models, the second part of the two-sided ML model may undergo CL using LRs, e.g., a UE-side model may be updated using CL techniques based at least in part on LRs stored at the UE. The first part of the two-sided ML model may be frozen (or include a frozen part) and updated infrequently (i.e., on a longer timescale than the CL updates). When the first part of the model is updated, the LRs stored at the UE may become outdated and need updating.

In the following description, two-sided ML models are described in which the initial stages of the ML model are performed on the network/gNB-side, and the final stages of the ML model are performed UE-side, i.e., ML inference goes from the gNB to the UE. However, it will be appreciated that two-sided ML models also include models in which the initial stages of the ML model are performed on the UE-side, and the final stages of the ML model are performed at the network/gNB-side, i.e., model inference goes from the UE to the gNB.

Examples of two-sided ML models in which inference goes from the gNB to the UE include beam management models and/or UE-side selection models. Examples of two-sided ML models in which inference goes from the UE to the gNB include compression models. For example, the UE-side of the ML model may comprise an encoder for compressing CSI into an encoded representation, and the gNB-side of the ML model may comprise a decoder for decompressing the encoded representation to reconstruct the CSI encoded at the UE. Other examples of two-sided ML models include ML-assisted mobility predictions at the UE and/or gNB, as well as ML-assisted UE positioning. Many other examples are possible.

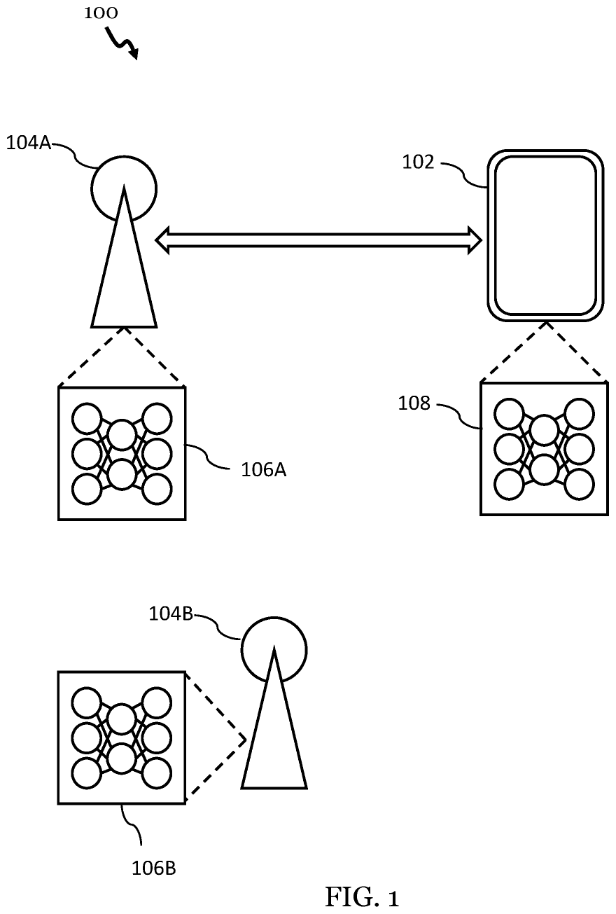

FIG. 1 shows an overview of a network system 100 for implementing a two-sided ML model. The system 100 comprises a user equipment system 102 (UE) and one or more base stations 104A, 104B.

A base station 104A, 104B is a network element providing an air interface between the radio units of mobile subscribers and the networks infrastructure (sometimes referred to as Switching and Management Infrastructure, SwMI). The base station 104A, 104B is responsible for radio transmission and reception to and from wireless subscriber stations over the air interface. A base station 104A, 104B may alternatively be known as a nodeB, eNodeB, gNodeB (gNB) or simply transmission point (TP). Many examples of base station structures will be familiar to the skilled person. Embodiments and examples are described herein with reference to gNBs, though they are applicable to other types of base station as well.

A user equipment 102 (UE) may be a mobile computing device, such as a mobile phone, tablet computer, laptop or other portable computing device, that is equipped with an antenna array for transmitting and/or receiving signals. The UE 102 may be an Internet of Things (IoT) device, such as a sensor, actuator and/or appliance. The UE 102 communicates with a core network via a base station 104A, 104B.

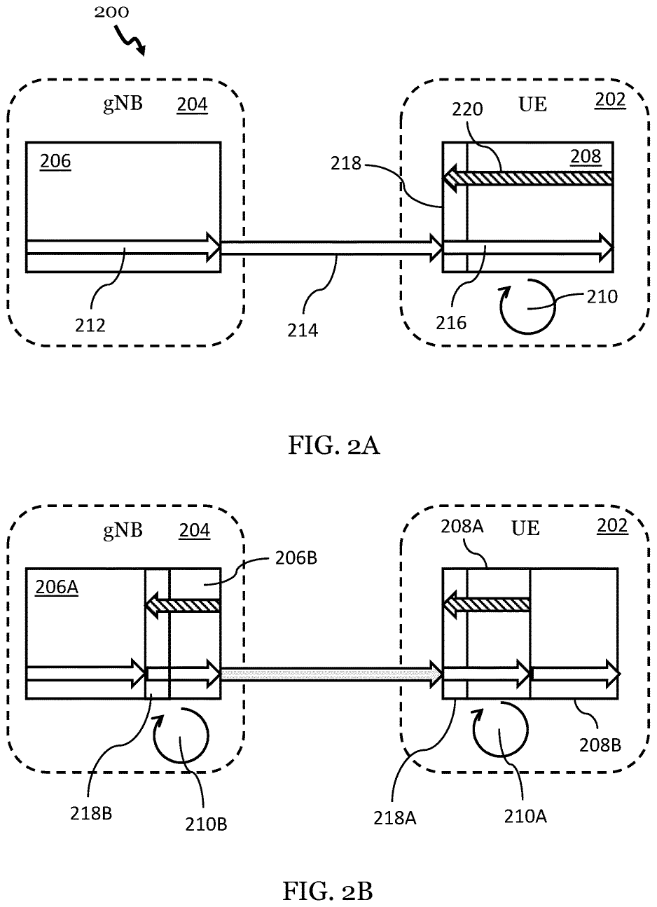

The system 100 is configured to execute one or more two-sided machine-learning (ML) models, for example as described in relation to FIGS. 2A and 2B. The two-sided ML model comprises a base station-side model 106A, 106B, executed by a base station 104A, 104B or network, and a UE-side model 108 executed by the UE 102. In general, the base station-side models 106A, 106B can be different due to training on local radio conditions. In the example shown, the UE 102 is connected to a first base station 106A, and hence the two-sided model uses the base station-side model 106A of the first base station and the UE-side model 108 to perform ML functionality.

FIG. 2A shows an example of a two-sided ML model 200. In this example, a gNB 204 executes a first part 206 of the ML model (also referred to herein as the “gNB-side model”, “gNB-side model part” or “network-side model”), which in this example has only a frozen stage. A UE 202 executes a second part 208 of the ML model (also referred to herein as the “UE-side model” or “UE-side model part”), which in this example has only an adaptive stage. Parameters of the UE-side 208 of the ML model are updated using a CL process 210, while parameters of the gNB-side 206 of the ML model are updated infrequently (i.e., “frozen” on the timescale of the CL updates). However, it will be appreciated that in some alternative examples the first part of the ML model is executed by the UE 202, with the second part of the ML model is executed by the gNB 204.

The two-sided ML model 200 is, in some examples, a neural network model. The neural network model comprises a plurality of neural network layers, e.g., feed-forward layers, convolutional layers, recurrent layers or the like. The two-sided ML model 200 is parametrised by a plurality of parameters, e.g., weights and/or biases of nodes of the neural network. In some examples, the neural network includes one or more skip connections between layers.

During inference, input data (not shown) is input into the gNB-side 206 of the ML model, which processes it in a forward pass 212 to generate an intermediate hidden state of the ML model. The intermediate hidden state of the ML model is transmitted 214 from the gNB 204 to the UE 202. The intermediate hidden state of the ML model is input into the UE-side 208 of the ML model, which processes it in a forward pass 216 to generate an output of the model (not shown).

The UE-side model part 208 is updated using a CL process 210. Updating the UE-side model part 208 using a CL process can allow the UE 202 to adapt to changing radio conditions in its environment. The UE-side model part 208 is updated based on a set of recent inputs to the ML model and a set of latent replays 218 generated from earlier inputs. The UE-side model part 208 is updated using, for example, using an optimisation routine applied to a loss/objective function, e.g., stochastic gradient descent. Gradients of the loss/objective function are backpropagated 220 through layers of the UE-side model part 208 to determine updates to the parameters of the UE-side model. The update may be based on supervised or unsupervised learning techniques. In the example shown, the LR 216 is used as the input for training the UE-side model part 208.

FIG. 2B shows a further example of a two-sided ML model. In this example, a gNB 204 executes a gNB-side model part 206 of the ML model, which in this example includes a frozen stage 206A and an adaptive stage 206B. A UE 202 executes a UE-side model part 208 of the ML model, which in this example includes an adaptive stage 208A and a frozen stage 208B. The frozen stage 208B of the UE-side model is preceded by the adaptive stage 208A in this example; this can reduce the need for regenerating latent replays on the UE-side during latent replay updates. However, in some examples, the frozen stage 208B of the UE-side model may come before the adaptive stage 208A. It will be appreciated that in some alternative examples the first part of the ML model is executed by the UE 202, with the second part of the ML model is executed by the gNB 204.

Parameters of the adaptive stage 208A of the UE-side ML model and adaptive stage 206B of the gNB-side model are updated using a CL processes 210A, 210B respectively. The updates for the adaptive stage 208A of the UE-side ML model and adaptive stage 206B of the gNB-side model are based on a set of recent inputs/outputs processed by the two-sided ML model and a respective set of LRs 218A, 218B, as described with respect to FIG. 2A.

Parameters of the frozen stage 206A of the gNB-side ML model are updated infrequently (i.e., “frozen” on the timescale of the CL updates). The frozen stage 208B of the UE-side model may be updated infrequently, if at all.

While FIG. 2A and FIG. 2B are described with respect to a gNB, it will be appreciated that the gNB can be replaced by other ML-capable nodes in a 3GPP network.

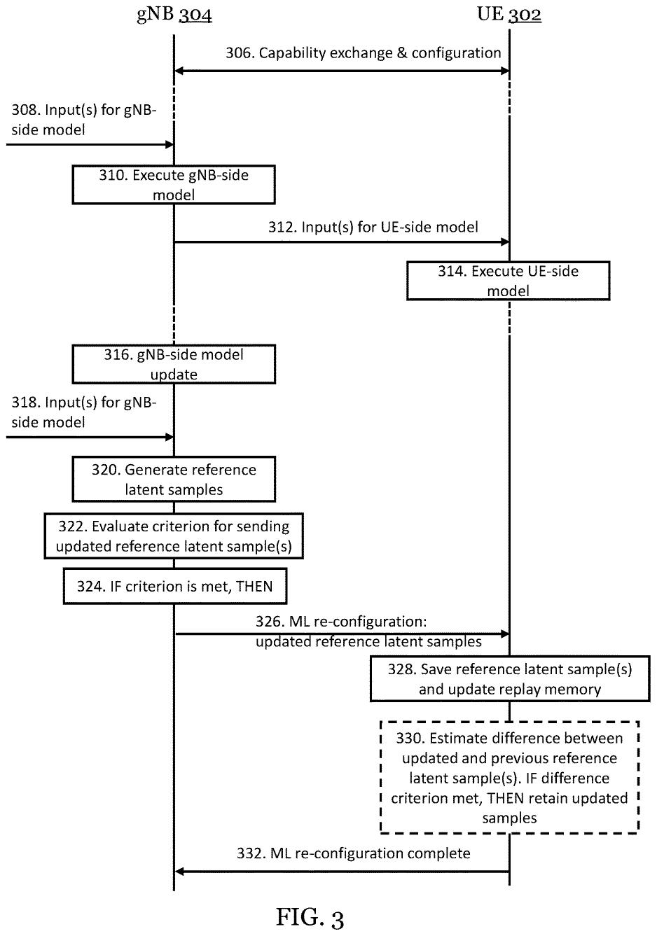

FIG. 3 shows an example signalling diagram for updating latent replays of a two-sided ML model. In the example shown, a gNB 304 executes the initial stages of the two-sided ML model and a UE 302 executes the final stages of the two-sided ML model. In this example, the gNB triggers updates to reference LR samples due to updates to the gNB-side ML model, i.e., the update of the gNB-side ML model is a trigger condition for updating the LR samples at the UE.

At operation 306, the UE 302 and gNB 304 exchange capabilities and CL configuration data. The CL configuration data is, in some examples, performed at the RRC level. The capabilities and CL configuration data comprises, in some examples, an amount of updated LR samples that the UE 302 is capable of processing. The capabilities and CL configuration data comprises, in some examples, one or more evaluation criteria for the gNB 304 and/or UE 302. The evaluation criteria can include, for example, a threshold difference value.

At operation 308, inputs for the gNB-side model are received. In some examples, the model inputs are received periodically, e.g., every time a fixed period of time elapses. Alternatively, in some examples, receipt of the model inputs is triggered by an event, e.g., a measurement event and/or a network event.

At operation 310, the gNB-side model is executed using the input data to generate one or more intermediate hidden states of the ML model. The input received at operation 308 is passed through frozen and/or adaptive layers of the gNB-side model, which processes them based on current values of the gNB-side model parameters to obtain the one or more intermediate hidden states. The intermediate hidden states (also referred to as “intermediate latent representations”) of the ML model are used as inputs for the UE-side model.

At operation 312, the intermediate hidden states of the ML model are transmitted from the gNB 304 to the UE 302. In some examples, the intermediate hidden states of the ML model are transmitted periodically, e.g., every time a fixed period of time elapses. Alternatively, in some examples, transmission of the intermediate hidden states is triggered by an event, e.g., a measurement event, network event and/or request from the UE 302.

At operation 314, the UE-side model is executed using the received intermediate hidden states of the ML model to generate a model output. The intermediate hidden states are passed through the adaptive layers and, if present, the frozen layers of the UE-side model, which processes them based on current values of the UE-side model parameters to obtain the model output. The UE-side model may be updated based on the recently processed input data and LR samples stores in a replay buffer of the UE 302 using a continuous learning process. Th LR samples correspond, for example, to hidden states generated from an initial set of training data on which the two-sided ML model was trained, e.g., before the fine tuning/CL process.

At operation 316, the gNB-side model is updated. This can result in the LR samples in a replay buffer of the UE 302 becoming outdated, since they depend on the output of the gNB-side model.

At operation 318, reference input data for the gNB-side model are received. The reference input data, in some examples, comprises input data/training data from an original training set on which the two-sided ML model was trained.

At operation 320, the gNB-side model uses the reference input data to generate one or more updated LR latent samples. The reference input data is processed by the gNB-side model based on current values of the gNB-side model parameters to obtain the one or more updated reference LR samples.

At operation 322, one or more evaluation criteria for sending updated reference LR samples are checked. For example, the one or more updated reference LR replay samples are compared to previous reference LR samples (e.g., reference latent samples from one or more previous times) and checked against a threshold value. The threshold value is, for example, the threshold value provided by the UE 302 at operation 306. If the difference between an updated reference LR replay samples and the corresponding previous reference LR sample is greater than the threshold value, the gNB 304 determines that said updated reference LR sample should be transmitted to the UE 302.

As an example, a metric is used to determine distances between the updated reference LR samples and the previous reference LR samples in latent space. Any suitable metric can be used, e.g., an L2 or L1 metric, or a cosine similarity. If the distance between an updated reference LR sample and a corresponding previous reference LR sample is greater than a predefined value, delta, then said updated reference LR sample is retained (i.e., included for transmission to the UE 302). If the distance between an updated reference latent sample and a corresponding previous reference latent sample is smaller than the predefined value, delta, then said updated reference LR sample is discarded (i.e. not included for transmission to the UE 302) The parameter delta cam be a configurable parameter; a small value of delta will cause even small changes to the gNB-side model to result in updated reference LR samples being transmitted to the UE 302, while a large value of delta prevents smaller changes to the gNB-side model from requiring updated reference LR samples at the UE. The parameter delta is, in some examples, fixed at the gNB 304. Alternatively, the parameter delta is provided to the gNB when the UE 302 exchanges capabilities and CL configuration data with the gNB 304 at operation 306.

In some examples, the updated reference LR samples are generated at a time T and compared to reference LR samples generated by the gNB-side model at a plurality of previous times, e.g., T-k and T-2k for the example of two previous time steps. In some examples, the number of previous time steps to be used is provided by the UE 302 as part of operation 306. If the difference is significant only between reference LR samples at T and T-2k, the gNB 304 may discard only part of the reference LR samples before T-k.

At operations 324 and 326, if the one or more criteria for sending updated reference LR replay samples, the gNB 304 transmits an ML reconfiguration message to the UE 302. The ML reconfiguration message comprises one or more updated reference LR samples, e.g., the updated reference LR samples that differ from previous reference LR samples by greater than a threshold value. In some examples, the ML reconfiguration message further comprises additional configuration information, such as a time in the past that previous LR samples were valid until. In some examples, the gNB 304 transmits the ML reconfiguration message to all connected UEs 302 that are configured for CL.

At operation 328, the UE 302 saves the updated reference LR samples and updates the replay memory of the UE 302.

In some implementations, as an alternative or in addition to operations 322 and 324, at operation 330 the UE 302 estimates a difference between the updated reference LR samples and previous reference LR samples stored in the replay memory of the UE 302. If the difference is above a threshold value, then the UE 302 retains the updated reference LR sample and discards the corresponding previous reference LR sample. If the difference is not above the threshold value, then the UE discards the updated reference LR sample and retains the corresponding previous reference LR sample. In this manner, the UE 302 manages its own replay memory based on its own criteria, which may be dependent on the UE capabilities.

Alternatively, the UE 302 overwrites the reference LR replay samples stored in its replay buffer that correspond to the received updated reference LR replay samples without performing any evaluation of the received updated reference LR replay samples. This can reduce processing at the UE 302, saving power.

At operation 332, the UE 302 transmits an ML reconfiguration complete message the gNB 304. The ML reconfiguration complete message indicates the use of the updated LR replay samples by the UE 302. In examples where the UE 402 evaluates differences between the updated and previous reference LR samples, the ML reconfiguration complete message indicates which of the updated LR replay samples are in use by the UE 302.

Subsequently, the UE 302 uses the updated set of LR reference samples stored in its memory (e.g., in the replay buffer) to perform CL.

In some implementations, the examples shown in FIG. 3 may be adapted to account for dynamic ML UE capabilities, i.e., where the UE 302 capabilities evolve over time. In such examples, the gNB 304 requests the UE 302 capabilities after it has been updated, and the UE responds with message containing its current capabilities (e.g., a number of LR samples it can handle).

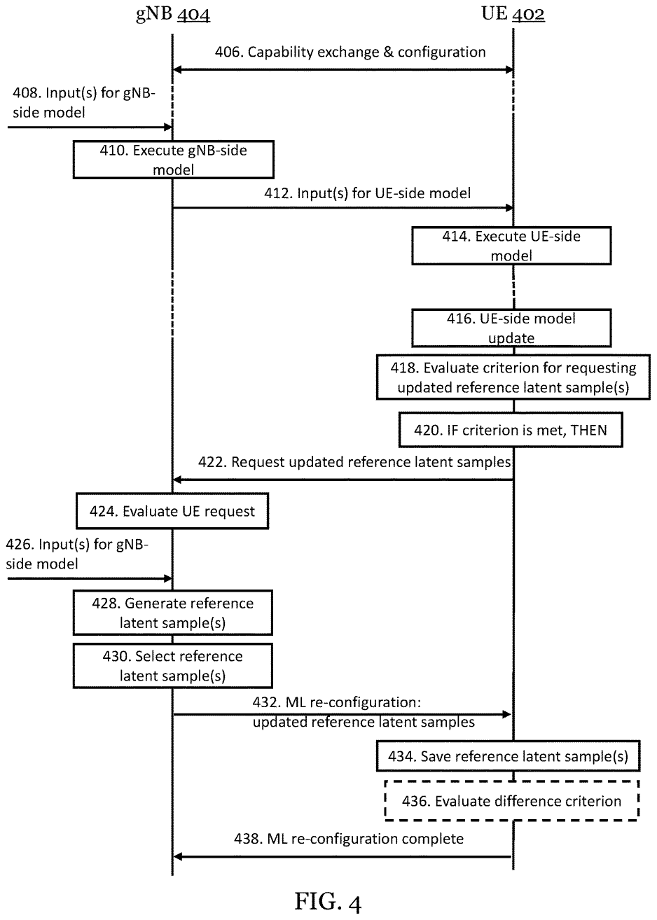

FIG. 4 shows a further example signalling diagram for updating LR replays of a two-sided ML model. In the example shown, a gNB 404 executes the initial stages of the two-sided ML model and a UE 402 executes the final stages of the two-sided ML model. In this example, the UE 402 triggers the update of the reference LR replay samples when its adaptive stages are updated and/or changes are detected in (radio) input conditions. Such UE 402 triggering can reduce signalling overhead in examples where the gNB-side model also has an adaptive stage undergoing CL.

At operation 406, the UE 402 and gNB 404 exchange capabilities and perform RRC-level continuous learning configuration. At operation 408, the gNB 404 receives inputs for the gNB-side model. At operation 410, the gNB executes the gNB-side model using the input data to generate one or more intermediate hidden states of the ML model. At operation 412, the gNB 404 transmits the intermediate hidden states of the ML model to the UE 402. At operation 414, the UE 402 executes the UE-side model using the received intermediate hidden states of the ML model to generate a model output. Operations 406 to 414 are described in further detail herein with respect to operations 306 to 314 of FIG. 3.

At operation 416, the UE 402 updates the UE-side model based on recently processed data and one or more reference LR samples stored, for example, in a replay buffer. In some examples, the UE-side model comprises an adaptive stage and a frozen stage. Parameters of the adaptive stage are updated during update of the UE-side model, while the parameters of the frozen stage remain unchanged. In other examples, the UE-side model is completely adaptive, i.e., has no frozen stage.

At operation 418, the UE evaluates one or more request criteria for requesting updated reference LR samples. The one or more request criteria may comprise the performance of the UE-side model falling below a threshold performance, which may indicate that the reference LR samples at the UE 402 are diverging from those garneted by the gNB 404. The one or more request criteria may comprise a threshold amount of time elapsing since the UE last updated the reference LR samples. Other examples of request criteria can include one or more of: a frequency band switch by the UE 402; a frequency band selection by the UE 302; a mobility state change of the UE 302; a mobility velocity change of the UE 30; and/or a traffic pattern change.

At operations 420 and 422, if the UE 402 determines that one or more of the request criteria are satisfied, then the UE transmits an update request to the gNB 404. The request is, in some examples, transmitted at the RRC level. Alternatively, in some examples the request is transmitted at the MAC level.

At operation 424, the gNB 404 evaluates the UE request. The gNB 404 determines whether to accept or deny the UE request based on one or more criteria. For example, a change rate criterion may be used. The change rate criterion comprises checking a rate at which requests for changes in the LR have been received from the UE 402. If the rate is below a threshold value, the gNB 404 proceeds to operation 424 and starts generating new/updated LR.

At operation 426, the gNB 404 receives one or more reference inputs for the gNB-side model. At operation 428, the gNB-side model generates one or more updated reference LR samples. The reference input data is processed by the gNB-side model based on current values of the gNB-side model parameters to obtain the one or more updated reference LR samples. At operation 430, the gNB 404 selects one or more of the updated reference LR samples for transmission to the UE 402. At operation 432, the gNB 404 transmits an ML reconfiguration request to the UE 402. The ML reconfiguration request comprises the selected one or more updated reference LR samples. At operation 434, the UE 402 saves the updated reference LR samples and updates the replay memory of the UE 402. Operations 426 to 434 may correspond to operations 318-328 of FIG. 3.

In some implementations, as an alternative or in addition to operation 430 at operation 436 the UE 402 estimates a difference between each of the updated reference LR samples and a corresponding previous reference LR sample stored in the replay memory of the UE 402, and discards reference replay samples from its memory, accordingly, as described herein in relation to operation 330 of FIG. 3.

At operation 438, the UE 402 transmits an ML reconfiguration complete message the gNB 404. The ML reconfiguration complete message indicates the use of the updated LR samples by the UE 402. In examples where the UE 402 evaluates differences between the updated and previous reference LR samples, the ML reconfiguration complete message indicates which of the updated latent replay samples are in use by the UE 402. Operation 438 may correspond to operation 332 of FIG. 3.

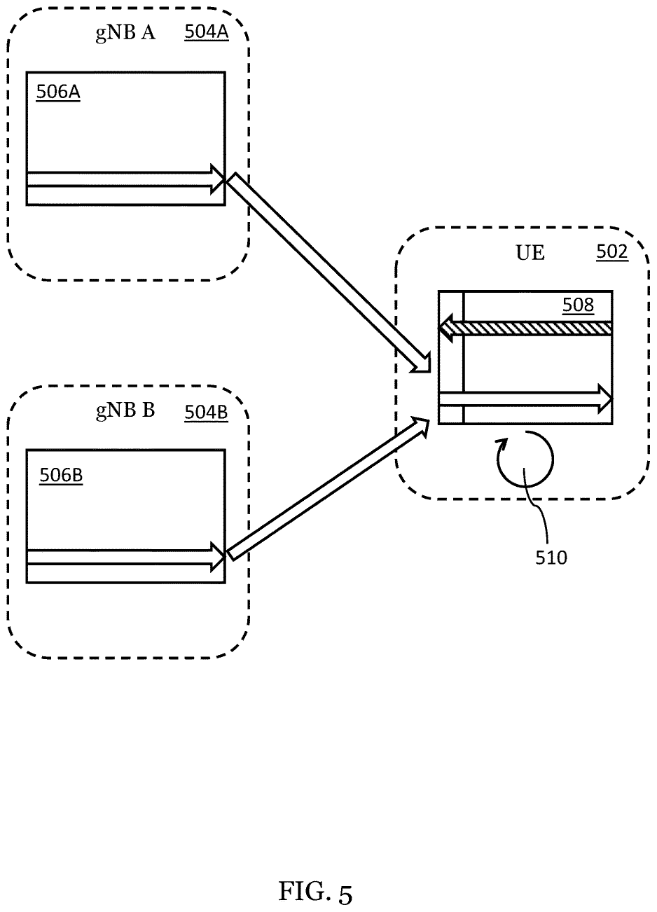

FIG. 5 shows an overview of a handover scenario for a UE 502 between two base stations: a source gNB 504A to which the UE 502 is currently connected; and a target gNB 504B to which the UE 502 is to be handed over to. Each base station 504A, 504B executes a respective first portion 506A, 506B of a two-sided ML model. The UE 502 executes a second portion 508 of the two-sided ML model. In the examples shown, the two-sided ML model corresponds to the model shown in FIG. 2A, i.e., the gNB-side models 504A, 504B are frozen, and the UE-side model is fully adaptive and undergoes CL 510. However, it will be appreciated that the two-sided model may alternatively correspond to the model in FIG. 2B, i.e., where either or both sides of the two side model have an adaptive and frozen stage.

In general, the first portions 506A, 506B of the ML model at different gNBs 504A, 504B can be different, as the models are trained on data collected at the respective gNBs. In examples where the first portions 506A, 506B are frozen, each gNB 504A, 504B train its respective model incrementally based on its local data or local radio conditions. Alternatively, for examples where the first portions 506A, 506B have a frozen stage and an adaptive stage, the ML model training in the source gNB 504A and target gNB 504B can be coordinated (e.g., using data collected from both cells), such that they use the same frozen stages, and only their adaptive stages are trained based on local data or radio conditions.

In both cases, when a UE handover is performed, any differences between the LR samples at the UE collected when served by source gNB (gNB A) and the LRs of the target gNB (gNB B) needs to be validated and re-aligned with UE-side ML model. The latent replay sample validation and re-alignment can potentially involve changes to the adaptive stage of the UE-side ML model.

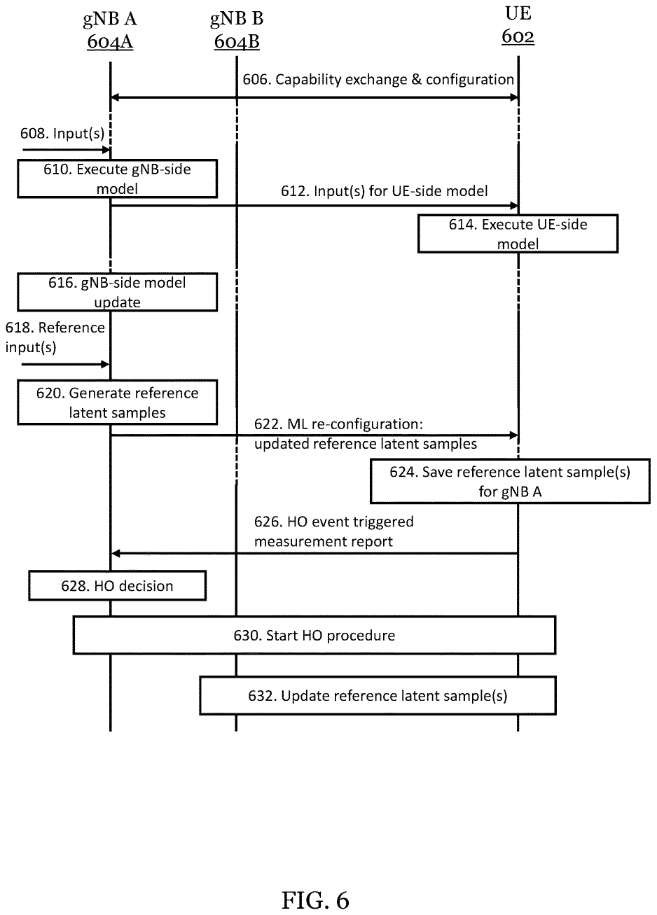

FIG. 6 shows an example signalling diagram for the initial stages of a handover of a UE 602 between two base stations 604A, 604B. In the example shown, a gNBs 604A, 604B execute initial stages of a two-sided ML model and a UE 402 executes the final stages of the two-sided ML model. The processes of FIGS. 6-9 are in some ways similar to those of FIGS. 3 and 4, except that the old LRs and updated LRs belong to two different gNBs 604A, 604B.

At operation 606, the UE 602 and gNB A 604A exchange capabilities, as described with respect to operation 306 of FIG. 3 and operation 406 of FIG. 4. At operation 608, the gNB A 604A receives inputs for the gNB-side model. At operation 610, gNB A 604A executes the gNB-side model using the input data to generate one or more intermediate hidden states of the ML model. At operation 612, gNB A 604 transmits the intermediate hidden states of the ML model to the UE 602. At operation 614, the UE 602 executes the UE-side model using the received intermediate hidden states of the ML model to generate a model output. The UE-side model may be updated using a continuous learning process based on the intermediate hidden states received from gNB A 604A and a set of latent replays stored, for example, in a replay buffer of the UE 602.

At operation 616, the first portion of the ML model at gNB A 604A may be updated. The first portion of the ML model may be updated infrequently, i.e., not based on a continuous learning process. Once updated, gNB A 604A receives one or more reference inputs (e.g., a plurality of reference inputs) at operation 618, and uses the one or more reference inputs to generate one or more updated reference LR samples (e.g. a plurality of reference latent samples) at operation 620. In some implementations (not shown), gNB A 604A performs an evaluation on the updated reference LR samples to determine which (if any) samples to send to the UE 602. Examples of such evaluations are described herein with respect to operation 322 of FIG. 3. At operation 622, an ML reconfiguration message is transmitted from gNB A 604A to the UE 602. The ML reconfiguration message comprises one or more of the updated reference latent samples. At operation 624, the UE 602 receives the updated reference LR samples and saves them to a memory, e.g., a replay buffer of the UE 602. In some implementations (not shown), the UE 602 performs an evaluation process to determine which, if any, of the updated reference LR samples to retain and/or whether to discard the stored LR samples, e.g., the LR samples in the replay buffer. Examples of such evaluations are described herein with respect to operation 330 of FIG. 3.

Operations 606 to 624 are described in further detail herein with respect to operations 306 to 330 of FIG. 3.

At operation 626, the UE 602 transmits a measurement report to gNB A 604A. The measurement report is triggered by a measurement event, such a measurement by the UE 602 of one or more signal qualities crossing corresponding threshold values, e.g., RSRP (Reference Signal Received Power) and RSRQ (Reference Signal Received Quality) measurements. Examples of measurement events that trigger measurement reporting are described in 3GPP 36.331 5.5.4. At operation 628, gNB A 604A determines, using the measurement report, to handover the UE 602 to gNB B 604B. At operation 630, gNB A 604A initiates handover of the UE 602 to gNB B 604B. The handover decision and handover procedure may be based on any technique(s) known in the art, e.g., as described in 3GPP 36.300.

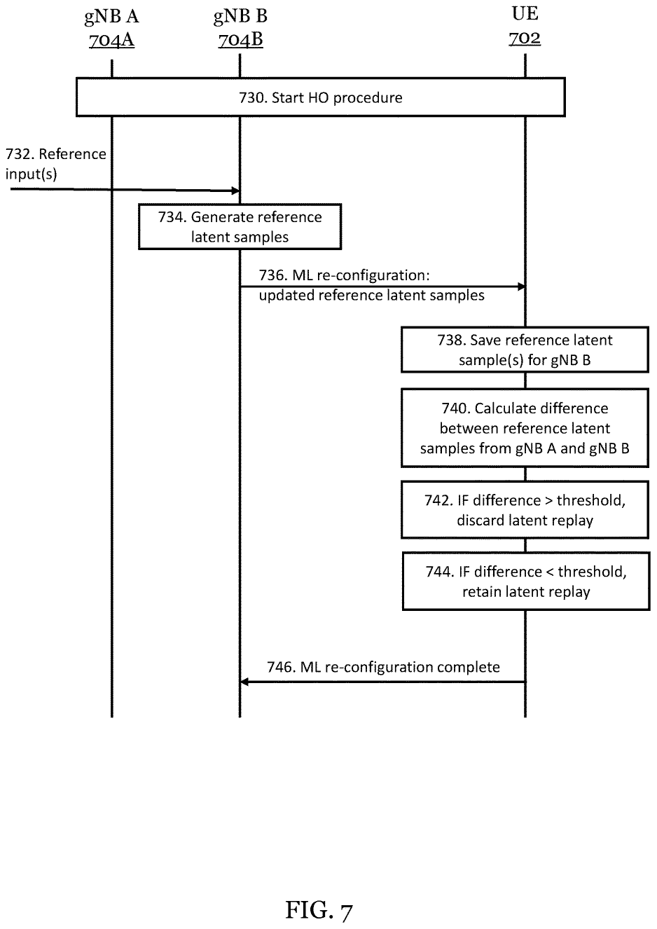

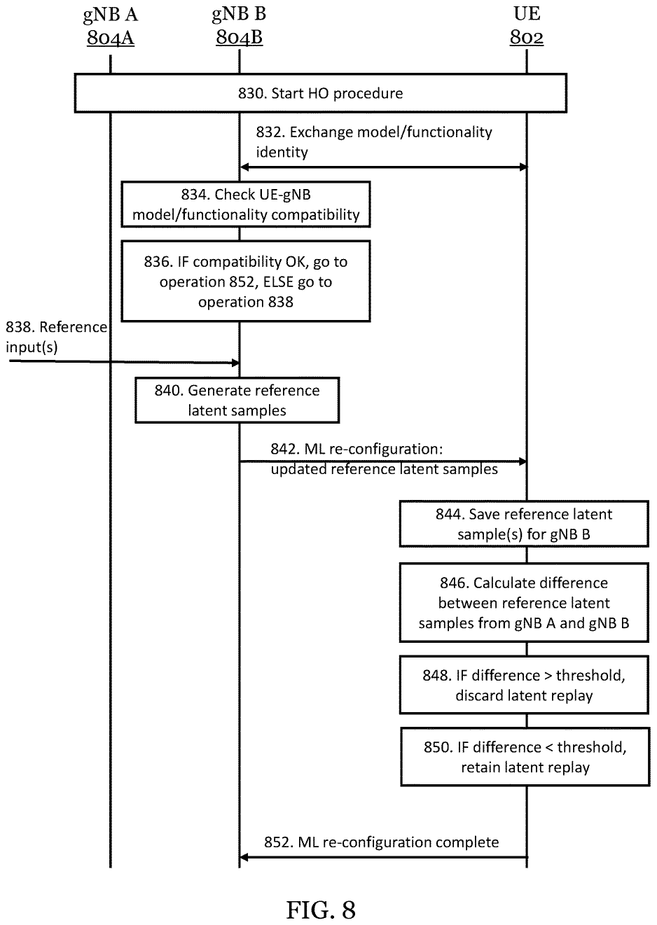

After initiation of the handover procedure, at operation 632 the UE 602 and gNB B 604B communicate to update the reference LR samples stored at the UE 602, if required. Examples of methods for updating the reference LR samples stored at the UE 602 are described herein with respect to FIGS. 7 and 8. Operation 632 may be performed as part of the handover procedure, or after the handover procedure is completed.

FIG. 7 shows an example signalling diagram for updating reference LR samples stored at a UE 702 after a handover procedure 730 between gNB A 704A and gNB B 704B. In summary, at the beginning of RRC re-connection to the target gNB B 704B, gNB B 704B sends a reference LR sample(s) to the UE 702. The UE 702 compares the new reference LR sample(s) with the previous LR reference samples it has received from source gNB 704A. Criteria used by the UE 702 to compare the reference LR samples may be included in the two-sided ML mode/functionality configuration (e.g., the continuous learning capability exchange). A number of the updated reference latent samples may also depend on the exposed UE 702 capabilities. The signalling mechanism from target gNB 704B may be the same as described in FIGS. 3 and 4: e.g., a ML re-configuration message (RRC), triggered by the target gNB B 704B after the UE HO. After the UE 702 has verified the use of the new LR samples, the UE sends an ML re-configuration complete message (RRC signalling) to the target gNB 704B to indicate that the new latent replay samples are being used.

In further detail, at operation 732, gNB B 704B receives one or more refence inputs (e.g., a plurality of reference inputs). The one or more reference inputs, in some examples, are one or more inputs from the training set on which the two-sided ML model was originally trained. At operation 734, gNB B 704B uses its version of the first portion of the two-sided ML model to generate one or more updated reference LR samples for gNB B 704B. The reference inputs are processed by the first portion of the ML model at gNB B 704B based on current values of parameters of the first portion of the ML model at gNB B 704B. The hidden state of a final layer of the first portion of the ML model at gNB B 704B for each reference input is used as the updated reference LR sample for that reference input.

At operation 736, gNB B 704B transmits an ML reconfiguration request to the UE. The ML reconfiguration message comprises one or more updated reference LR samples. The ML reconfiguration request may be communicated at the RRC level.

At operation 738, the UE 702 saves the updated reference LR samples from gNB B 704B in a memory of the UE. At operation 740, the UE determines a difference between each updated reference LR sample from gNB B 704B and a corresponding reference LR sample from gNB A 704A that is stored in the memory of the UE 702. The difference may be based on a distance in latent space between the updated reference LR sample from gNB B 704B and its corresponding reference LR sample from gNB A 704A. At operation 742, the UE 702 discards reference LR samples from gNB A 704A (and retains those from gNB B 704B) when the distance is greater than a threshold value. At operation 744, the UE 702 retains reference LR samples from gNB A 704A (and discards those from gNB B 704B) when the distance is less than a threshold value. Further details of this process are described, for example, with reference to operation 330 of FIG. 3.

At operation 746, the UE 702 sends an ML reconfiguration complete message to gNB B 704B. The ML reconfiguration complete message is described in further detail with respect to operation 332 of FIG. 3.

FIG. 8 shows a further example signalling diagram for updating reference latent samples stored at a UE 802 after initiation/completion of a handover procedure 830 between gNB A 804A and gNB B 804B. This example uses ML Model or ML Functionality identification (e.g., an ID, tag, and/or label, description) to decide if model/functionality at a target gNB 804B is different from the model/functionality at source gNB 704A. The Model/Functionality identifier information can be used as a criterion to determine the need for updated reference LR sample(s), i.e., as a trigger for generating the updated reference LR samples.

At operation 832, the UE 802 and gNB B 804B exchange model identity/functionality data. The model identity data may indicate a version and/or functionality of the second portion of the two-sided ML model used by the UE 802 and or the first portion of the two-sided ML model used gNB A 804A. The model identity/functionality data may comprise one or more of: one or more IDs, one or more tags and/or one or more labels. The model identity/functionality data may indicate a version of the LR samples stored at the UE 802.

At operation 834, gNB B 804B checks the compatibility of the model gNB B 804B with the UE model. In some examples, gNB B 804B compares the identity data/compatibility data provided by the UE 802 to a list of identities/functionality that are supported by the first portion of the ML model at gNB B 804B.

At operation 836, if the UE-side model is compatible with the gNB-side model at gNB B 804B, then the process proceeds to operation 852, as no updated reference LRs are required at this stage. If the UE-side model is compatible with the gNB-side model at gNB B 804B, then the process proceeds to operation 838.

At operation 838, gNB B 804B receives one or more reference inputs. At operation 840, gNB B 804B generates updated reference LR samples using the first portion of the two-sided ML model used at gNB B 804B. At operation 842, gNB B 804B transmits an ML reconfiguration request comprising the updated reference LR samples to the UE 802. At operation 844, the UE determines a difference between each updated reference LR sample from gNB B 804B and a corresponding reference LR sample from gNB A 804A that is stored in the memory of the UE 802. The difference may be based on a distance in latent space between the updated reference LR sample from gNB B 804B and its corresponding reference LR sample from gNB A 804A. At operation 848, the UE 702 discards reference LR samples from gNB A 704A (and retains those from gNB B 704B) when the distance is greater than a threshold value. At operation 850, the UE 702 retains reference LR samples from gNB A 804A (and discards those from gNB B 704B) when the distance is less than a threshold value. The UE 802 then transmits a ML reconfiguration complete message to gNB B 804B.

Operations 838-850 may correspond to operations 318-320 and 326-332 described in relation to FIG. 3 and operations 732-746 of FIG. 7.

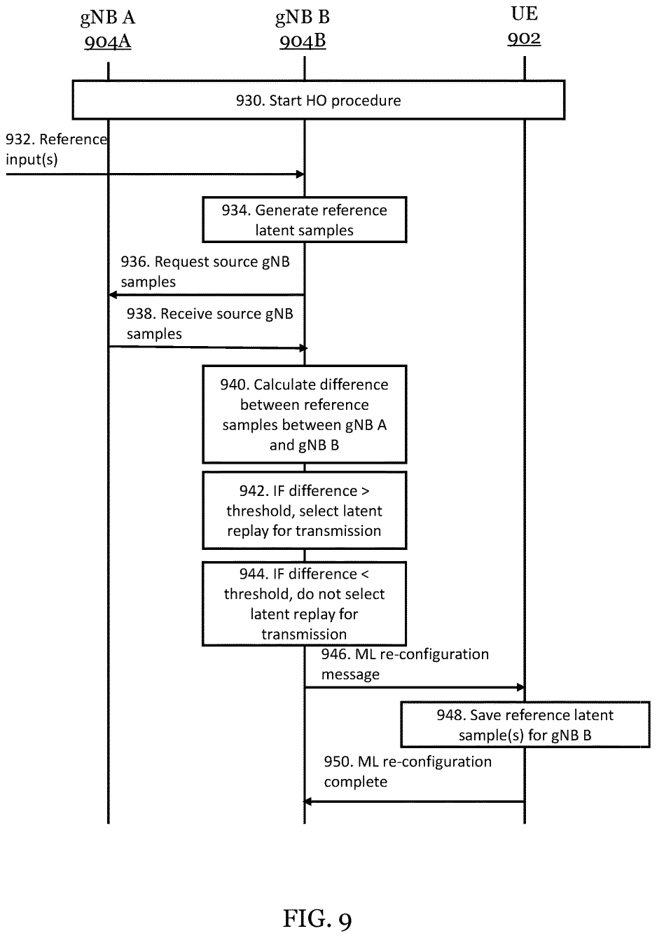

FIG. 9 shows a further example signalling diagram for updating reference latent samples stored at a UE 702 after a handover procedure 930 between gNB A 904A and gNB B 904B. In this example, the serving gNB 904A sends its reference LR samples to the target gNB 904B via a network interface (e.g., an X2 interface). A comparison of the LR samples from the source gNB 904A and target gNB 904B is then made at the target gNB. If the difference is important (e.g., above a threshold value) then the target gNB 904B sends the reference LR samples to UE 902 which will directly use them, without performing any further verification. This can save resources and time at the UE 902.

At operation 932, gNB B 904B receives one or more refence inputs (e.g., a plurality of reference inputs). At operation 934, gNB B 904B uses its version of the first portion of the two-sided ML model to generate one or more updated reference LR samples for gNB B 904B. These operations may correspond to operations 732 and 734 of FIG. 7.

At operation 936, gNB B 904B requests LR samples from gNB A 904A. At operation 938, gNB A 904A transmits its LR samples to gNB B 904B. The request and its response are communicated via a network interface between the source 904A and target 904B gNBs, e.g., via a core network/X2 interface.

At operation 940, gNB B 904B determines differences between of the updated reference LR samples and corresponding reference LR samples received from gNB A. At operation 942, if the difference between an updated reference LR sample and its corresponding reference LR samples received from gNB A is greater than a threshold value, gNB B 904B 902 determines that that said updated reference LR samples should be included for transmission to the UE 902. At operation 944, if the difference between an updated reference LR sample and its corresponding reference LR samples received from gNB A is less than a threshold value, gNB B 904B 902 determines that that said updated reference LR samples should not be included for transmission to the UE 902. Operations 940-944 may correspond to operations 322 and 324 of FIG. 3, with the previous reference LR samples of FIG. 3 corresponding to the reference LR samples received from gNB A.

At operation 946, gNB B 902B transmits an ML reconfiguration message comprising the updated reference LR samples selected at operation 942 to the UE 902. At operation 948, the UE 902 saves the reference LR samples from gNB B 904B. At operation 950, the UE 902 sends a ML reconfiguration message to gNB B 904B. Operations 946-950 may correspond to operations 326, 328 and 332 of FIG. 3.

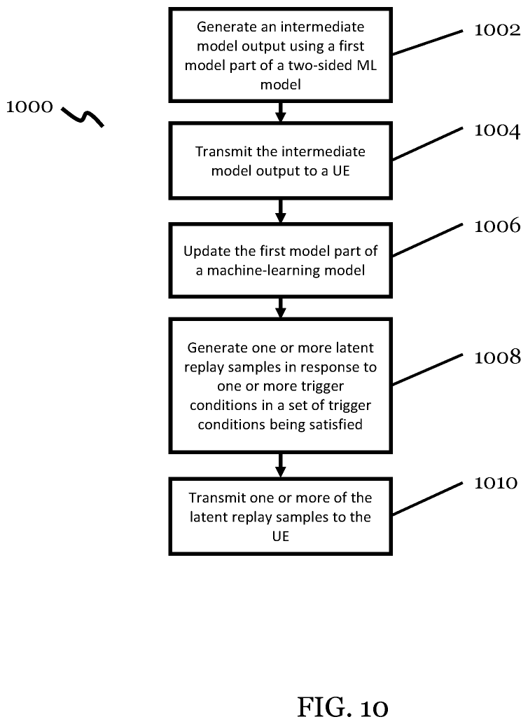

FIG. 10 shows a flow diagram of an example method for managing a set of latent replay samples in a two-sided ML model. The method may be performed by a base station, e.g., a gNB. Alternatively, in examples where the first part of the ML model is executed on a UE, the method may be performed by a UE. In the following, the method is described in relation to a first apparatus and a second apparatus, with the first apparatus executing the first stage of the two-sided ML model and the second apparatus executing the second stage of the two-sided ML model. In some examples, the first apparatus is a base station, and the second apparatus is a UE. In some examples, the first apparatus is a UE, and the second apparatus is a base station.

In some examples, prior to operation 1002, the first apparatus and second apparatus exchange capabilities and/or CL configuration data. The capabilities and/or CL configuration data may comprise one or more evaluation criteria for the UE and/or base station for determining which latent replay samples to transfer. The capabilities and/or CL configuration data may comprise a maximum number of latent replay samples that can be handled by the UE.

At operation 1002, the first apparatus executes a first model part of an ML model to generate an intermediate model output. The ML model is a two-sided ML model comprising the first model part for execution at the first apparatus and a second model part for execution at the second apparatus. The two-sided ML model may be a neural network comprising a plurality of layers, e.g., feedforward layers, fully connected layers, convolutional layers, recurrent layers, LSTM layers, transformer layers and/or softmax layers. In such examples, the first model part of the two-sided ML model may comprise a sequence of layers that is a proper subset of the two-sided model.

The first model part of the ML model receives the input data and processes it through a series of ML layers based on current values of parameters (e.g., weights and biases) of the first model part of the ML model. The intermediate model output corresponds to the hidden state of the final layer of the first portion of the ML model.

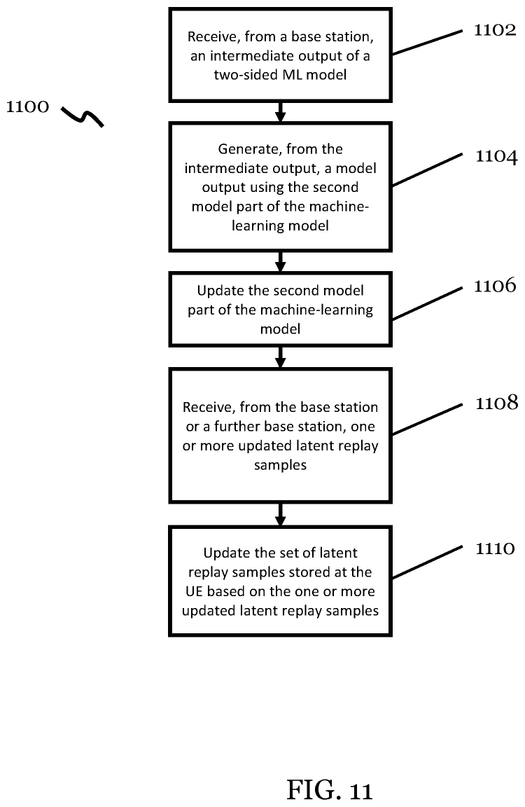

At operation 1004, the first apparatus transmits the intermediate model output to the second apparatus. The second apparatus uses the intermediate model output as input to the second model part of the two-sided ML model, and processes it to generate one or more outputs of the two-sided ML model, as described with respect to FIG. 11.

At operation 1006, the first apparatus updates the first model part of the machine-learning model. The updates are, in some examples, performed infrequently (e.g., on a much longer timescale than the CL process(es) performed by the second apparatus), i.e. the first model part is a frozen model part. Alternatively, an adaptive stage of the first model part is updated using a CL process, with a frozen stage of the first model part updated infrequently. The update may be based on local radio conditions at the first apparatus. In some examples, the updates are based on applying an optimisation routine to a loss/objective function, e.g., stochastic gradient descent.

At operation 1008, the first apparatus generates one or more latent replay samples in response to one or more trigger conditions in a set of trigger conditions being satisfied. The one or more latent replay samples each comprise an intermediate model output generated by the updated first model part of the ML model from a respective reference input, e.g., the hidden state of the final layer of the first portion of the two-sided ML model. Each reference input comprises, in some examples, an input from a training dataset that was used to train the two-sided model.

The one or more trigger conditions comprise, in some examples, the first portion of the two-sided ML model being updated, for example as described with respect to FIG. 3. Alternatively or additionally, the one or more trigger conditions comprise receiving a request from the second apparatus for updated reference latent replay samples, for example as described with respect to FIG. 4. Alternatively or additionally, the one or more trigger conditions comprise a handoff of a UE to a base station from a different base station, for example as described with respect to FIGS. 6-9.

At operation 1010, the base station transmits one or more of the latent replay samples to the second apparatus. The latent replay samples may be transmitted as part of a ML reconfiguration request to the second apparatus. The first apparatus may communicate the latent replay samples to the second apparatus at the RRC level.

To save on signalling bandwidth, in some examples the first apparatus selects one or more of the generated latent replay samples for transmission based on one or more evaluation criteria. The base station transmits latent replay samples that satisfy the one or more evaluation criteria to the second apparatus; latent replay samples that do not satisfy the one or more evaluation criteria are discarded.

In some examples, an evaluation criterion may be based on a comparison of each of the generated latent replay samples to corresponding latent replay samples generated at one or more previous times. If the difference is above a threshold value, the evaluation criterion is satisfied. If the difference is below a threshold value, the evaluation criterion is not satisfied.

In some examples, an evaluation criterion may be based on a comparison of each of the generated latent replay samples to corresponding latent replay samples generated at an additional/third apparatus, e.g. a source base station from which a UE is being handed over. In such examples, the method further comprises requesting the corresponding latent replay samples from the third apparatus and receiving the corresponding latent replay samples from the third apparatus. If the difference is above a threshold value, the evaluation criterion is satisfied. If the difference is below a threshold value, the evaluation criterion is not satisfied.

In either case, the differences may be based on a distance between latent replay samples in the latent space in which they reside. The distance may be determined using a metric, e.g. an L1 or L2 metric, or a cosine similarity.

FIG. 11 shows a flow diagram of a further example method for managing a set of latent replay samples for a two-sided ML model. The method may be performed by a UE. Alternatively, in examples where the first part of the ML model is executed on a UE, the method may be performed by a base station. In the following, the method is described in relation to a first apparatus and a second apparatus, with the first apparatus executing the first stage of the two-sided ML model and the second apparatus executing the second stage of the two-sided ML model. In some examples, the first apparatus is a base station, and the second apparatus is a UE. In some examples, the first apparatus is a UE, and the second apparatus is a base station.

In some example, prior to operation 1102, the first apparatus and second apparatus exchange capabilities and/or CL configuration data. The capabilities and/or CL configuration data may comprise one or more evaluation criteria for the UE and/or base station for determining which latent replay samples to transfer. The capabilities and/or CL configuration data may comprise a maximum number of latent replay samples that can be handled by the UE and/or base station.

At operation 1102, the UE receives, from the first apparatus, an intermediate output of a ML model. The ML model is a two-sided ML model comprising a first model part executed at the first apparatus and a second model part for execution by the second apparatus. The two-sided ML model may be a neural network comprising a plurality of layers, e.g. feedforward layers, fully connected layers, convolutional layers, recurrent layers, LSTM layers, transformer layers and/or softmax layers. In such examples, the first and second model parts of the two-sided ML model each comprise a sequence of layers that is a proper subset of the two-sided model. The intermediate output comprises the hidden state of the final layer of the first portion of the two-sided ML model generated from a set of input data.

At operation 1104, the second apparatus generates, from the intermediate output, a model output using the second model part of the machine-learning model. The second portion of the ML model receives the intermediate output as input and processes it through a series of ML layers based on current values of parameters (e.g. weights and biases) of the second portion of the ML model to generate the model output. The model output may, for example, be a classification and/or prediction of one or more radio properties.

At operation 1106, the second apparatus updates the second portion of the machine-learning model. The updates may be performed using a CL process. The updates may be based at least in part on a set of latent replay samples stored at the second apparatus and a set of recent data collected by the UE/base station. The updates may be based on applying an optimisation routine to a loss/objective function, e.g. using stochastic gradient descent.

In some examples, a proper subset of layers of the second model part of the machine-learning model are updated, while the remaining layers remain fixed, e.g. the second model part of the machine-learning model comprises a frozen stage and an adaptive stage. Alternatively, the whole of the second model part of the machine-learning model is adaptive during the CL process.

At operation 1108, the second apparatus receives, from the first apparatus or an additional apparatus (e.g. a further base station), one or more updated latent replay samples. The one or more updated latent replay samples comprise an updated intermediate model output generated by an updated first portion of the machine-learning model, as described in relation to operation 1008 of FIG. 10. Transmission of the updated latent replay samples may be triggered by a request from the second apparatus, as described in relation to FIG. 4. Alternatively, transmission of the updated latent replay samples may be triggered by the first apparatus.

At operation 1110, the second apparatus updates the set of latent replay samples stored at the second apparatus based on the one or more updated latent replay samples. In some implementations, the second apparatus directly replaces reference LR samples stored at the second apparatus with corresponding updated reference latent replay samples.

Alternatively, the second apparatus may compare the updated reference latent replay samples to the samples currently stored in a replay buffer of the second apparatus, and replace only the current reference samples that have a difference greater than a threshold value. In such examples, the second apparatus compares the one or more updated latent replay samples to a corresponding one or more latent replay samples stored at the second apparatus and selecting, based on the comparison of the one or more updated latent replay samples to the corresponding one or more latent replay samples stored at the second apparatus, one or more of the updated latent replay samples for storage at the second apparatus.

Subsequent to operation 1110, the CL process performed at the second apparatus is based on the updated set of latent replay samples at the second apparatus.

### Example Apparatus

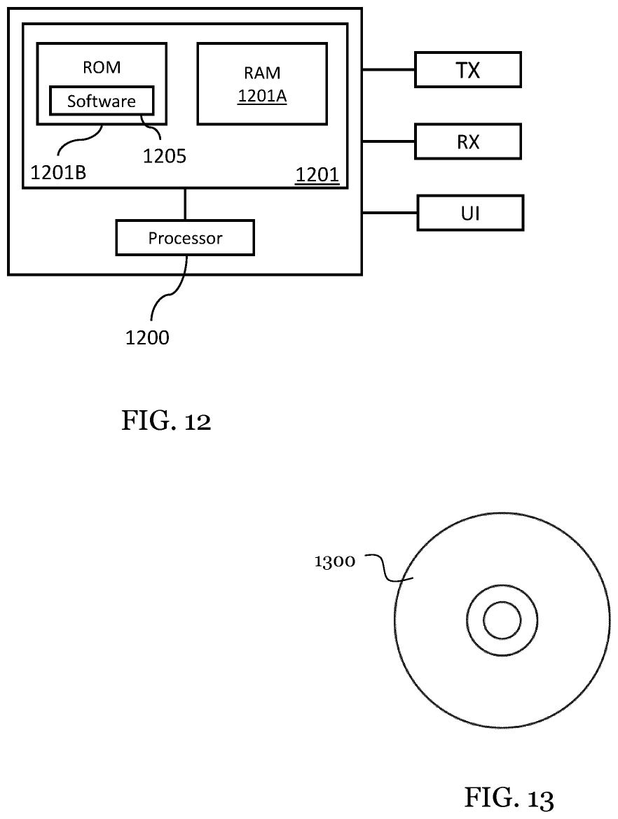

FIG. 12 shows an apparatus according to some example embodiments, which may form at least a part of a user equipment or a base station. The apparatus may be configured to perform the operations described herein, for example operations described with reference to any disclosed process. The apparatus comprises at least one processor 1200 and at least one memory 1201 directly or closely connected to the processor. The memory 1201 includes at least one random access memory (RAM) 1201A and at least one read-only memory (ROM) 1201B. Computer program code (software) 1205 is stored in the ROM 1201B. The apparatus may be connected to a transmitter (TX) and a receiver (RX). The apparatus may, optionally, be connected with a user interface (UI) for instructing the apparatus and/or for outputting data. The at least one processor 1200, with the at least one memory 1201 and the computer program code 1205 are arranged to cause the apparatus to at least perform at least the method, or a part of the method, according to any preceding process, for example as disclosed in relation to the flow diagrams of FIGS. 10 and/or 11 and related features thereof.

FIG. 13 shows a non-transitory media 1300 according to some embodiments. The non-transitory media 1300 is a computer readable storage medium. It may be e.g., a CD, a DVD, a USB stick, a blue ray disk, etc. The non-transitory media 1300 stores computer program code, causing an apparatus to perform the method of any preceding process for example as disclosed in relation to the flow diagrams and related features thereof.

Names of network elements, protocols, and methods are based on current standards. In other versions or other technologies, the names of these network elements and/or protocols and/or methods may be different, as long as they provide a corresponding functionality. For example, embodiments may be deployed in 2G/3G/4G/5G networks and further generations of 3GPP but also in non-3GPP radio networks such as WiFi.

A memory may be volatile or non-volatile. It may be e.g., a RAM, a SRAM, a flash memory, a FPGA block ram, a DCD, a CD, a USB stick, and a blue ray disk.

If not otherwise stated or otherwise made clear from the context, the statement that two entities are different means that they perform different functions. It does not necessarily mean that they are based on different hardware. That is, each of the entities described in the present description may be based on a different hardware, or some or all of the entities may be based on the same hardware. It does not necessarily mean that they are based on different software. That is, each of the entities described in the present description may be based on different software, or some or all of the entities may be based on the same software. Each of the entities described in the present description may be embodied in the cloud.

Implementations of any of the above-described blocks, apparatuses, systems, techniques or methods include, as non-limiting examples, implementations as hardware, software, firmware, special purpose circuits or logic, general purpose hardware or controller or other computing devices, or some combination thereof. Some embodiments may be implemented in the cloud.

It is to be understood that what is described above is what is presently considered the preferred embodiments. However, it should be noted that the description of the preferred embodiments is given by way of example only and that various modifications may be made without departing from the scope as defined by the appended claims.

1-21. (canceled)

22. An apparatus, comprising:
at least one processor; and
at least one memory storing instructions that, when executed by the at least one processor, cause the apparatus at least to:
execute a first model part of a machine-learning model to generate an intermediate model output, wherein the machine-learning model is a two-sided machine-learning model comprising the first model part for execution by the apparatus and a second model part for execution at a further apparatus;
cause transmission of the intermediate model output to the further apparatus;
update the first model part of a machine-learning model;
generate, in response to one or more trigger conditions from a set of trigger conditions, one or more latent replay samples, the one or more latent replay samples each comprising an intermediate model output generated by the updated first model part of the machine-learning model from a respective refence input; and
transmit, to the further apparatus, one or more of the latent replay samples.

23. The apparatus of claim 22, wherein the set of trigger conditions comprises the updating of the first model part of a machine-learning model.

24. The apparatus of claim 22, wherein the at least one processor; and the at least one memory storing instructions that, when executed by the at least one processor, further cause the apparatus at least to:
receive, from the further apparatus, a request for latent replay sample updates,
wherein the set of trigger conditions comprises receiving, from the further apparatus, the request for latent replay sample updates.

25. The apparatus of claim 22, wherein the at least one processor; and the at least one memory storing instructions that, when executed by the at least one processor, further cause the apparatus at least to:
receive, from the further apparatus, further apparatus capability information comprising one or more evaluation criteria for selecting latent replay samples for transmission to the further apparatus;
evaluate, using the one or more latent replay samples generated after an update of the first model part of the machine learning model, the one or more evaluation criteria; and
select, based on the evaluation of the one or more evaluation criteria, one or more of the latent replay samples for transmission to the further apparatus.

26. The apparatus of claim 25, wherein the at least one processor; and the at least one memory storing instructions that, when executed by the at least one processor, further cause the apparatus at least to:
store one or more previous latent replay samples generated by the first model part of a machine-learning model,
compare the one or more latent replay samples generated after an update of the first model part of the machine learning model to a corresponding one or more previous latent replay samples generated prior to said update of the first model part of the machine learning model.

27. The apparatus of claim 26, wherein the at least one processor; and the at least one memory storing instructions that, when executed by the at least one processor, further cause the apparatus at least to:
determine a difference in latent space between each of the one or more latent replay samples and the corresponding previous latent replay samples, when comparing the one or more latent replay samples to the corresponding one or more previous latent replay samples; and
select the one or more of the latent replay samples for transmission to the further apparatus, based on the difference in latent space between each of the one or more latent replay samples and the corresponding previous latent replay samples being above a threshold value.

28. The apparatus of claim 22, wherein the apparatus is a base station and the further apparatus is a user equipment.

29. The apparatus of claim 28, wherein the set of trigger conditions comprises a handover of the user equipment to the base station from a further base station.

30. The apparatus of claim 29, wherein the at least one processor; and the at least one memory storing instructions that, when executed by the at least one processor, further cause the apparatus at least to:
receive, from the user equipment, data indicating a model identity and/or model capability of the second model part of the machine-learning model; and
determine whether a set of latent replays stored at the user equipment is compatible with the first model part of a machine-learning model based on the model identity and/or model capability of the second model part of the machine-learning model,
wherein the set of trigger conditions further comprises a determination that the first model part of a machine-learning model is not compatible with the set of latent replays stored at the user equipment.

31. The apparatus of claim 29, wherein the at least one processor; and the at least one memory storing instructions that, when executed by the at least one processor, further cause the apparatus at least to:
request, from the further base station, a set of latent reference samples;
receive, from the further base station, the set of latent reference samples; and
compare the received set of latent reference samples to the one or more latent replay samples generated at the apparatus,
transmit, to the user equipment, one or more of the latent replay samples is based on the comparison of the received set of latent reference samples to the one or more latent replay samples generated at the apparatus.

32. The apparatus of claim 22, wherein the first model part of the machine learning model comprises an adaptive stage that is updated using continuous learning techniques and frozen stage that is updated less frequently than the adaptive stage.

33. An apparatus, comprising:
at least one processor;
and at least one memory storing instructions that, when executed by the at least one processor, cause the apparatus at least to:
receive, from a further apparatus, an intermediate output of a machine-learning model, wherein the machine-learning model is a two-sided machine-learning model comprising a first model part executed at the further apparatus and a second model part for execution by the apparatus;
generate, from the intermediate output, a model output using the second model part of the machine-learning model;
store a set of latent replay samples;
update, based at least in part on the set of latent replay samples, the second model part of the machine-learning model;
receive, from the further apparatus or a further base station, one or more updated latent replay samples, the one or more updated latent replay samples comprising an updated intermediate model output generated by an updated first model part of the machine-learning model; and
update the set of latent replay samples based on the one or more updated latent replay samples.

34. The apparatus of claim 33, wherein the at least one processor; and the at least one memory storing instructions that, when executed by the at least one processor, further cause the apparatus at least to:
evaluate a request criterion for requesting updated latent replay samples; and
request, from the further apparatus, the one or more updated latent replay samples in response to a positive evaluation of the request criterion.

35. The apparatus of claim 33, wherein the at least one processor; and the at least one memory storing instructions that, when executed by the at least one processor, further cause the apparatus at least to:
compare the one or more updated latent replay samples to a corresponding one or more latent replay samples stored at the apparatus,
select, based on the comparison of the one or more updated latent replay samples to the corresponding one or more latent replay samples stored at the apparatus, one or more of the updated latent replay samples for storage at the apparatus.

36. The apparatus of claim 33, wherein the at least one processor; and the at least one memory storing instructions that, when executed by the at least one processor, further cause the apparatus at least to:
transmit, to the further apparatus, a configuration message comprising one or more evaluation criteria for use by the further apparatus to select latent replay samples for transmission to the apparatus.

37. The apparatus of claim 33, wherein the apparatus is a user equipment and the further apparatus is a base station.

38. The apparatus of claim 37, wherein the at least one processor; and the at least one memory storing instructions that, when executed by the at least one processor, further cause the apparatus at least to:
perform one or more measurements of signal quality of signals from the base station and a further base station;
determine to switch connection from the base station to the further base station; and
transmit, to a further base station, data indicating a model identity and/or model capability of the second model part of the machine-learning model in response to determining to switch connection to the further base station.

39. The apparatus of claim 38, wherein the at least one processor; and the at least one memory storing instructions that, when executed by the at least one processor, further cause the apparatus at least to:
transmit, to the base station or the further base station, a configuration complete message comprising an indication that updated latent replay samples are stored at the apparatus.

40. The apparatus of claim 33, wherein the second model part of the machine learning model comprises an adaptive stage that is updated using continuous learning techniques and frozen stage that is updated less frequently than the adaptive stage.

41. A method comprising:
receiving, from a first apparatus, an intermediate output of a machine-learning model, wherein the machine-learning model is a two-sided machine-learning model comprising a first model part executed at the first apparatus and a second model part for execution by a second apparatus;
generating, from the intermediate output, a model output using the second model part of the machine-learning model;
updating, based at least in part on a set of latent replay samples, the second model part of the machine-learning model;
receiving, from the first apparatus or a further apparatus, one or more updated latent replay samples, the one or more updated latent replay samples comprising an updated intermediate model output generated by an updated first model part of the machine-learning model; and
updating the set of latent replay samples based on the one or more updated latent replay samples.
